(19) United States
(12) Patent Application Publication
(10) Pub. No.: US 2026/0357610 A1
(43) Pub. Date: Nov. 12, 2026

(54) Fine Covers

(71) Applicant: Nicholas C. Parks, South Bend, IN (US)

(72) Inventor: Nicholas C. Parks, South Bend, IN (US)

(21) Appl. No.: 19/202,759

(22) Filed: May 8, 2025

(51) Int. Cl. E05B 1/00; E04F 11/18

(52) U.S. Cl. CPC E05B 1/0061; E04F 11/1836

(57) ABSTRACT

This product is developed to give groups of all ages a way to help better their everyday home lives. The product, (Fine Covers) consists of four different types of products the doorknob cover, cabinet knob cover, cabinet handle cover and an accessible handrail cover. The product is designed to cover over an existing product to prevent accidental damage or injury to yourself and others. The product, (Fine Covers) is made of a variety of colors that will fit the best user and glows in the dark for a proper direction at night. The product is equipped with an outer layer consisting of a featured design. This design is made risen up around the product for a more convenient grasp. The product has a gel on the inside layer that glows in the dark.

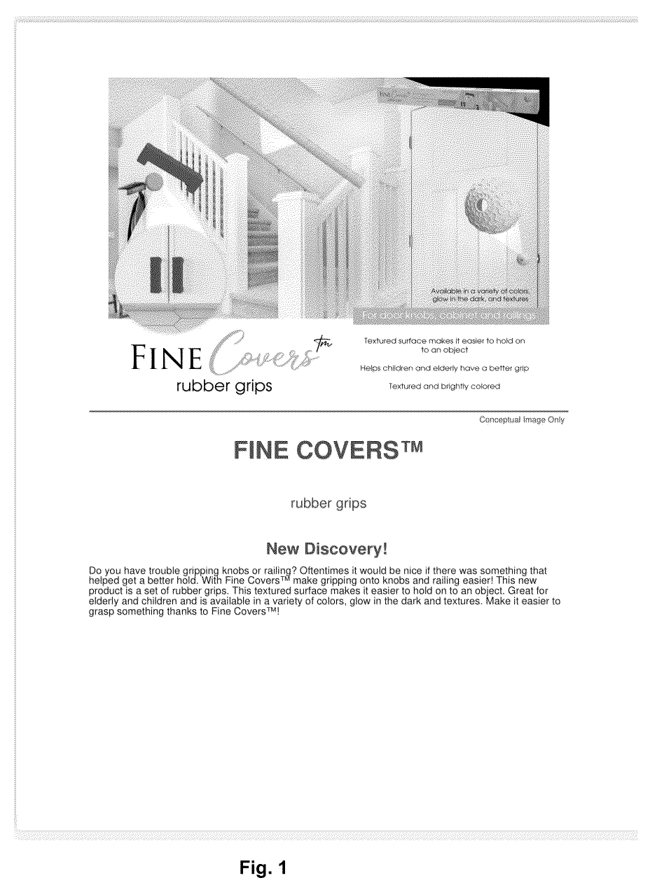

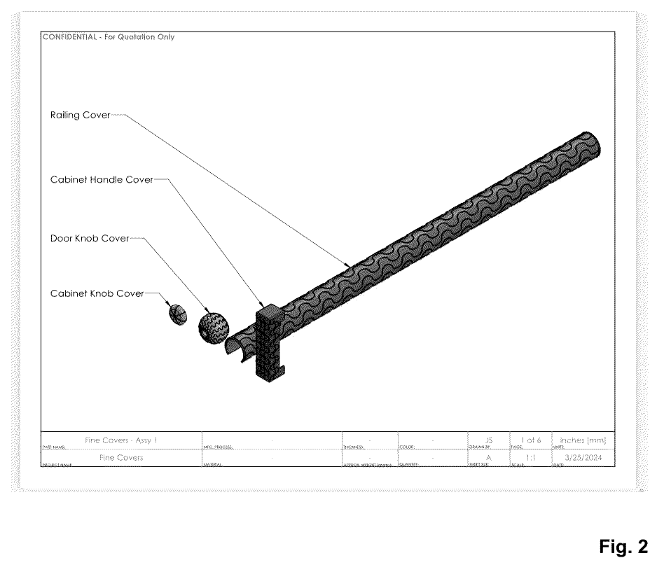

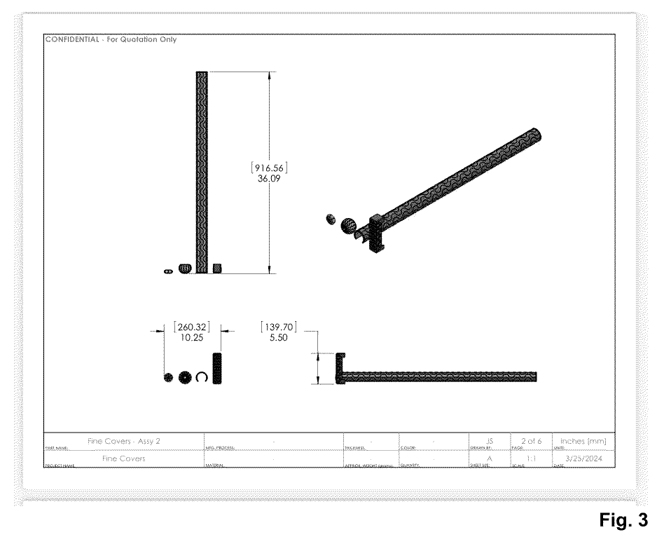

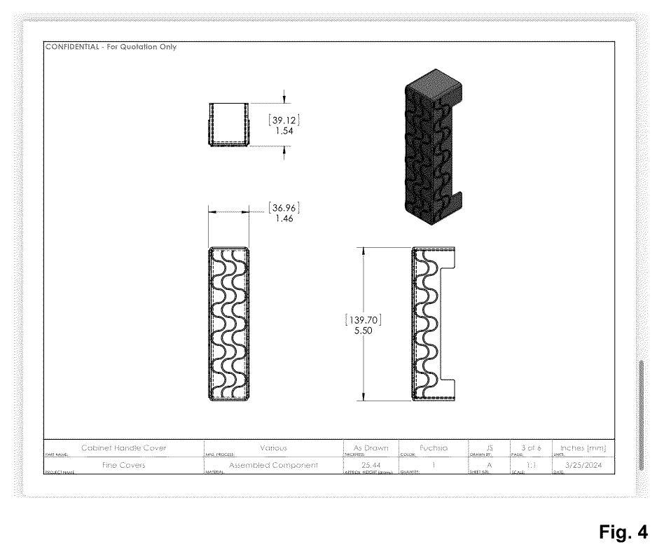

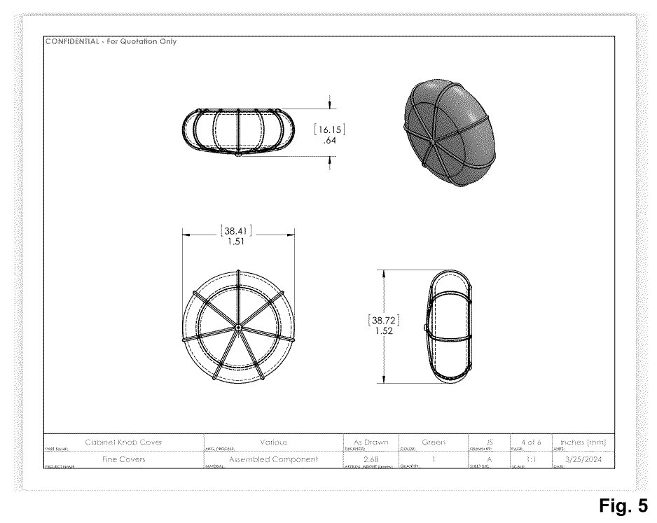

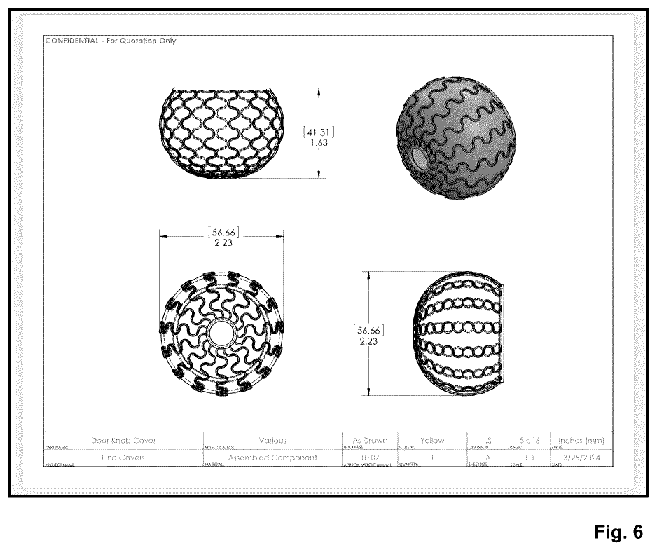

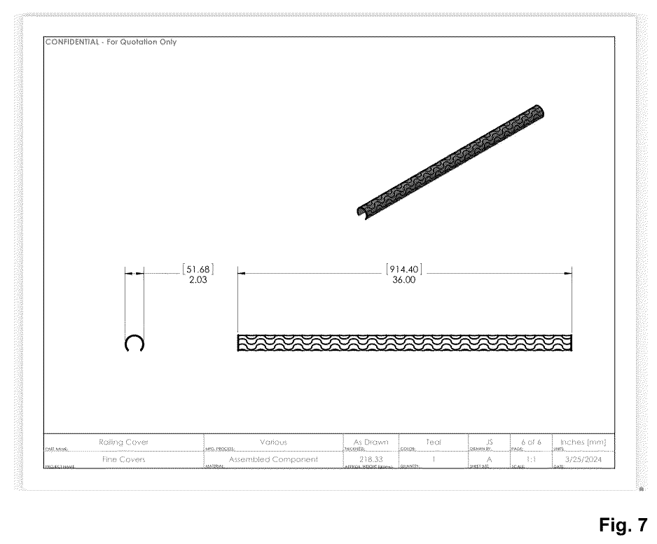

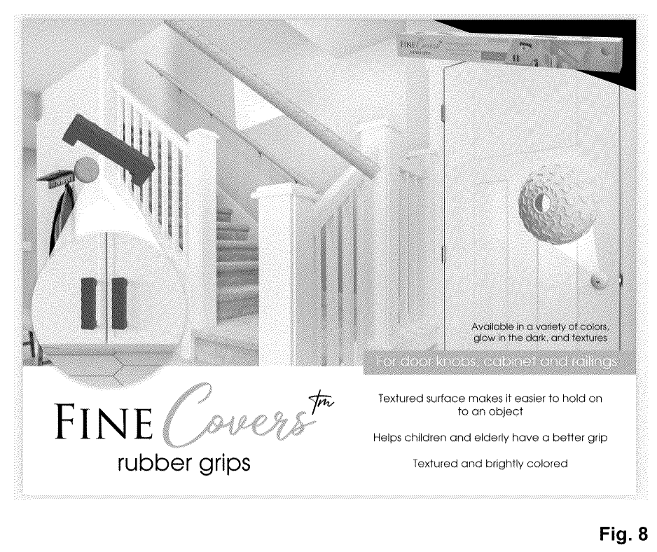

This product is developed to give groups of all ages a way to help better their everyday home lives. The product, (Fine Covers) consists of four different types of products: the door knob cover, cabinet knob and handle cover and an accessible handrail cover. The product is designed to cover over a existing product to prevent accidental damage or injury to yourself and others. The product, (Fine Covers) is made out of a variety of colors that will fit the best user and glows in the dark for a proper direction at night.

Whether it's day or night with trouble grasping certain objects or just having trouble seeing at night. These Products are intended to help people who developed shaky hands, arthritis and trouble seeing in the dark. The (Fine Cover) has a solution for you. The product is equipped with an outer layer consisting of a featured design. This design is made raised up around the product for a more convenient grasp. Because of the depth you can have the ability to hold on more firmly. If you are having trouble finding direction at night the product is equipped with a gel on the inside layer that glows in a dark setting.

1. A rubber handrail cover, wherein said rubber handrail cover:
comes in a variety of different colors;
is flexible to wrap around different handrails;
glows in the dark for direction at night;
has a textured design risen around the product for extra grip support.

2. A cabinetry rubber handle cover;
wherein the handle cover comes in a variety of different colors;
wherein the handle cover is flexible to stay snug around cabinet handles;
wherein the handle cover glows in the dark for direction at night;
wherein the handle cover has a textured design risen around the product for extra grip support.

3. A cabinetry rubber door knob cover;
wherein the cabinetry handle cover comes in a variety of different colors;
wherein the cabinetry handle cover is flexible to stay snug around cabinet handles;
wherein the cabinetry handle cover glows in the dark for direction at night;
wherein the cabinetry handle cover has textured design risen around the product for extra grip support.
